(19) United States
(12) Patent Application Publication
(10) Pub. No.: US 2017/0177865 A1
(43) Pub. Date: Jun. 22, 2017

(54) Industrial Control System Emulator for Malware Analysis

(71) Applicant: MalCrawler Co., Alexandria, VA (US)

(72) Inventor: Dewan Nadim Chowdhury, Alexandria, VA (US)

(21) Appl. No.: 15/451,404

(22) Filed: Mar. 6, 2017

Related U.S. Application Data
(63) Continuation-in-part of application No. 14/597,841, filed on Jan. 15, 2015, now abandoned.
(60) Provisional application No. 61/928,508, filed on Jan. 17, 2014.

(51) Int. Cl. G06F 21/56; H04L 29/06

(52) U.S. Cl. CPC G06F 21/56; H04L 63/083; H04L 63/1416; G06F 2221/034

(57) ABSTRACT

Embodiments of the present invention may provide an Industrial Control System (ICS) Emulator for Malware Analysis. The ICS Emulator may be embodied in a software. The software may be developed by testing and operating thousands of ICS devices that are used every day in critical infrastructure from power to oil & gas. Then, based on the tests and operations, the software may be configured to identify if, when, and how malware may be attacking various industrial control systems.

### RELATED APPLICATION

Under provisions of 35 U.S.C. §119(e), this application is a continuation in part of U.S. patent application Ser. No. 14/597,841, filed Jan. 15, 2015, which claims the benefit of priority to U.S. Provisional Patent Application No. 61/928,508, filed Jan. 17, 2014, both applications which are hereby incorporated by reference in their entirety for all purposes. It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to testing for malware.

### BACKGROUND

Industrial Control Systems (ICSs) are typically used in industries such as electrical, water, oil, gas and data. Based on data received from remote stations, automated or operator-driven supervisory commands can be pushed to remote station control devices, which are often referred to as field devices. Field devices control local operations, such as opening and closing valves and breakers, collecting data from sensor systems, and monitoring the local environment for alarm conditions.

In some situations, these critical infrastructures, key to national and economic security, are at risk. For example, malware can be used for disrupting operation, gathering sensitive information or otherwise interfering with the data in the ICS. Thus, regulators and the federal government are pressuring these companies to improve their defenses against malware cyber-attacks. The conventional strategy is to test each individual ICS devices in each configuration. This often causes problems because the conventional strategy requires a company to purchase and house the ICS devices, which can get costly.

### BRIEF OVERVIEW

Consistent with embodiments of the present disclosure, an Industrial Control System (ICS) Emulator for Malware Analysis may be provided. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope. As well be detailed in the present disclosure, the ICS Emulator may serve an integral role in protecting critical infrastructures including, but not limited, to power plants, oil and gas facilities and water treatment plants from cyber-attacks through malware.

Embodiments of the present invention may provide a software solution to address at least the problem discussed in the Background Section of this disclosure. The software may comprise an ICS emulator. The software may be developed by testing and operating thousands of ICS devices that are used every day in critical infrastructure from power to oil & gas. Then, based on the tests and operations, the software may be configured to identify if, when, and how malware may be attacking various industrial control systems. Consistent with embodiments of the present invention, the software may be configured to emulate an industrial control device. The emulation may be employed to determine, for example, if there exist any vulnerabilities within the industrial control device configuration. The vulnerabilities may make the industrial device vulnerable to, for example, malware attacks. The emulation may be employed for any useful purpose.

In order to determine the vulnerabilities, the software of the present invention may perform a behavioral analysis. The behavioral analysis may determine how the malware interacts with the industrial control device. The determination may derive several key elements. The key elements may comprise, for example, but not be limited to, a type of device being targeted by the malware, a medium through which the malware is communicating with the device, a type of communication protocol is being used by the malware, data types by object groups, and which action is the malware trying to perform on the device.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 is a flow chart of a method for providing the ICS Emulator for Malware Analysis; and

FIG. 2 is a block diagram of a system including a computing device for performing the method of FIG. 1.

### DETAILED DESCRIPTION

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

### I. PLATFORM OVERVIEW

Critical infrastructures, such as power plants, oil & gas facilities and water treatment plants, are at risk to cyber-attacks through malware. As of today there is no malware product specifically designed for the industry's industrial control systems. These critical infrastructures are key for national and economic security. Regulators and the federal government are pressuring these companies to improve their defenses against malware cyber-attacks. Conventional systems require a dedicated lab that consists of thousands of ICS devices and tens of thousands of configuration, which may cost an organization in the millions just to purchase and house these industrial devices.

Consistent with embodiments of the present disclosure, an Industrial Control System (ICS) Emulator for Malware Analysis may be provided. The emulator may replace the need for implementing dedicated labs. The ICS Emulator for Malware Analysis may be used by individuals or companies to determine if malware is attacking ICS devices.

The ICS Emulator may be embodied in a software. The software may be configured to perform a behavioral analysis on the malware. The analysis may monitor the malware to determine how the malware interacts with industrial controls devices in an ICS. The ICS may be associated with, for example, but not be limited to, Supervisory Control and Data Acquisition (SCADA) systems, Distributed Control Systems (DCS), Programmable Logic Controllers (PCL), Human Management Interfaces (HMI), Remote terminal units (RTU), Intelligent Electronic Devices (IED), supervisory computers, or control centers.

In various aspects, the ICS can comprise a control system architecture that utilizes at least one of computers, networked data communications, graphical user interfaces, and peripheral ICS devices. In further aspects, the ICS can be used for process supervisory management, for example, to monitor and control physical processes. In still further aspects, the peripheral devices can be used to interface to a process plant or machinery. In yet further aspects, the peripheral ICS device can comprise controllers, sensors, actuators, or communication devices, or the like. In some aspects, the peripheral ICS device can comprise Programmable Logic Controllers (PCL), Human Management Interfaces (HMI), Remote terminal units (RTU), or Intelligent Electronic Devices (IED), or the like.

In further aspects, the ICS can comprise closed or isolated system, for example, and without limitation, an ICS that is confined within a factory floor or plant. In still further aspects, the ICS can comprise highly distributed system, for example, and without limitation, an ICS that is geographically distributed. In yet further aspects, the ICS can control processes operated in isolated environments. In even further aspects, the ICS and/or ICS device can communicate only with other ICS and ICS devices within an isolated network. In some aspects, the ICS and ICS devices do not share information with systems or devices outside their environment or network. In other aspects, the ICS and ICS devices can share information with systems or devices outside their environment or network. In further aspects, the ICS or ICS devices do not comprise or utilize standard IT databases or IT assets (e.g. web server, DNS server, windows server, etc.).

For example, in exemplary aspects, an ICS can comprise a control center configured to perform centralized monitoring and control for field sites over a communications networks, including, and without limitation, monitoring alarms and processing status data. In still further aspects, the ICS can be configured to utilize information received from remote stations to perform actions, for example, and without limitation, to push automated or operator-driven supervisory commands to remote station control devices, or field devices in field sites. In still further aspects, field devices can be configured to control local operations such as, and without limitation, opening and closing valves or breakers, collecting data from sensor systems, monitoring the local environment for alarm conditions, or the like.

In further aspects, the ICS can collect and log information gathered by other ICS devices or field sites. In still further aspects, the information can be displayed to an HMI which may generate actions based upon detected events. In yet further aspects, the ICS or ICS device can be configured to perform centralized alarming, trend analyses, or reporting, or combinations thereof. In even further aspect, the ICS or ICS device can comprise supervisory control software configured to communicates with other ICS devices, such as, lower level control devices.

In further aspects, the HMI can be configured to allow human operators to monitor the state of a process under control, modify control settings to change the control objective, manually override automatic control operations in the event of an emergency, or combinations thereof. In still further aspects, the HMI can display process status and historical information to authorized users. In yet further aspects, location, platform, and interface of the HMI may vary. For example, according to some aspects of the invention, the HMI can be located on a dedicated workstation within the ICS environment or network. In other aspects, the HMI can be located on a laptop on a wireless LAN.

In further aspects, the ICS can comprise field sites configured to perform local control of actuators and monitoring of sensors. In still further aspects, a Remote Telemetry Unit (RTU) can comprise a special purpose data acquisition and control unit, for example, to support the operations of ICS remote stations. In yet further aspects, a Programmable Logic Controller (PLC) can comprise an industrial computer configured to perform logic functions executed by electrical hardware such as, and without limitation, relays, switches, mechanical timers, mechanical counters, or the like.

In further aspects, an Intelligent Electronic Device (IED) can comprise a smart sensor or actuator configured to acquire data, communicate to other devices, perform local processing and control, or combinations thereof. In still further aspects, an IED can comprise a plurality of components or functions, such as, and without limitations, an input sensor, output, low-level control capabilities, a communication system, or program memory, or combinations thereof.

In further aspects, the ICS or ICS devices can utilize various communication architectures. In still further aspects, the communication architecture can comprise point-to-point, series, series-star, multi-drop, or combinations thereof. In some aspects, ICS or ICS devices can utilize standard communication protocols. In other aspects, ICS or ICS devices can utilize proprietary communication protocols.

In various aspects, the ICS device can be configured to autonomously execute logic processes, for example, without involving another ICS device or supervisory computer. In further aspects, the ICS can employ standardized control programming languages such as, and without limitation, IEC 61131-3 (a suite of 5 programming languages including function block diagram (FBD), ladder diagram (LD), structured text (ST), instruction list (IL), and sequential function chart (SFC)). In still further aspects, the ICS or ICS device can comprise programs configured to run on a RTU, or PLC, or the like. In yet further aspects, unlike a procedural language such as the C programming language, the ICS programming language ICS can comprise a schematic diagram of relay logic, or “ladder-style logic” programming. For example, in some aspects, contact-coil logic can be used to make programs like an electrical control diagram. In even further aspects, design and implementation of a program can be executed on an RTU or PLC.

In further aspects, ICS devices, for example, PLCs, can be programmed using application software on computers or devices connected to the ICS device. In still further aspects, the logic can be presented in graphic form instead of character symbols. In yet further aspects, the programming application software can allow entry and editing of the program (e.g., ladder-style logic), including, but not limited to function block diagrams, sequence flow charts, or structured text, or the like. In still further aspects, the application software can be configured to upload and download the program to an ICS device. In some aspects, the program can be transferred from a computer to the ICS device (e.g., PLC) through a programming board which can write the program into a removable chip, such as, and without limitation, RAM, an EPROM, or some other flash memory.

In various aspects, a malware or malware attack can comprise any deliberate action to alter, disrupt, deceive, degrade and destroy ICS computer systems, devices or networks or the information and/or programs resident in or transiting these systems or networks.

A behavior analysis consistent with embodiments of the present invention may determine, at least, for example, if malware has targeted a specific device, a medium of communication being used to target the device, a communication protocol being used to communicate with the device, data types by object groups, and what function the malware may be attempting to perform on the device. In further aspects, the malware can utilize a remote-access or close-assess path to a target ICS or ICS device. For example, according to some aspects, a remote-access malware attack can be initiated at some geographical distance from the system, device, or network. In other aspects, a close-access malware attack can take place in close proximity to the computer or network, such as, and without limitation, an attack where the attacker has physical control over the device or network.

In various aspects, the present platform is configured to identify and analyze malware capable of interacting and controlling ICS devices. In further aspects, the malware is not configured to control IT assets (e.g. web server, DNS server, windows server, etc.). As described herein, in various aspects, ICS device are often programmed using control programming languages, and do not interact with IT malware, such as IT malware designed to interact with IT assets such as web server, DNS server, windows server, and the like. Accordingly, traditional IT malware detection tools are not capable of effectively identifying ICS malware capable of interacting with or controlling an ICS device. Moreover, traditional IT malware tools are not capable of emulating the ICS environment or performing an analysis on ICS malware attempting to do an action on an ICS device, such as a PLC.

In further aspects, the present platform is configured to scan the ICS or ICS device to identify any anomaly or anomalous file. The malware or anomalous file can be located on any part of the ICS device, including but not limited to the processing unit, system memory, data storage device, file system, or the like. After identifying an anomalous file, the file is extracted and tested using the industrial control system emulator for malware analysis.

In further aspects, the platform can be in the form of an installed agent on an ICS device and configured to find malware located on the device. In still further aspects, malware detection by the present platform does not require that the malware transmit data over a network, for example, local malware that was directly introduced onto an ICS or ICS device and configured not to transmit data over a network in order to evade detection.

In further aspects, unlike static analysis used in anti-virus, the present platform behavioral analysis can be based on dynamic analysis, such as, and without limitation, by observing the behavior of the malware while it is actually running on a host system.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. PLATFORM CONFIGURATION

Embodiments of this invention may comprise a plurality of physical ICS devices. The ICS device may comprise, for example, Supervisory Control and Data Acquisition (SCADA) systems, Distributed Control Systems (DCS), Programmable Logic Controllers (PCL), Human Management Interfaces (HMI), Remote terminal units (RTU), Intelligent Electronic Devices (IED), supervisory computers, or control centers. The devices may be manufactured by different entities. For testing, purposes, a variety of different devices from a variety of different manufacturers may be used. These ICS devices may then be configured to mimic actual operation in various fields. The fields may comprise, but not be limited to, for example, power (e.g., power generation, transmission, and distribution), substations and substation automation, oil & gas (e.g. exploration, extraction, pipeline, distribution, and refining), water, manufacturing, chemical processing, and many others.

Based on the operational results, a software consistent with the embodiments of the present invention may be developed. In turn, the software may then be used to emulate the actual ICS devices. The emulation may be based on, for example, the inputs and outputs from the ICS devices. The software may be developed to incorporate a plurality of aspects that would be found in a traditional ICS device.

Still consistent with embodiments of the present invention, an in-house malware for simulation may be developed. The simulation malware may be employed to verify the functionality of the emulator software. During the verification process, the simulation malware may be configured to perform various malicious acts in various controlled testing environments.

For example, these malicious acts performed by the simulation malware may be directed against the actual ICS devices in a first malware attack. The results of the first malware attack may then be documented. Next, the simulation malware may be employed to perform the malicious acts against the Emulator (i.e., the software) in a second malware attack. The results between the actual ICS devices and the ICS Emulator may then be compared. In various embodiments, the Emulator may be considered to be properly configured when the results between the two test attacks are substantially similar.

### III. PLATFORM OPERATION

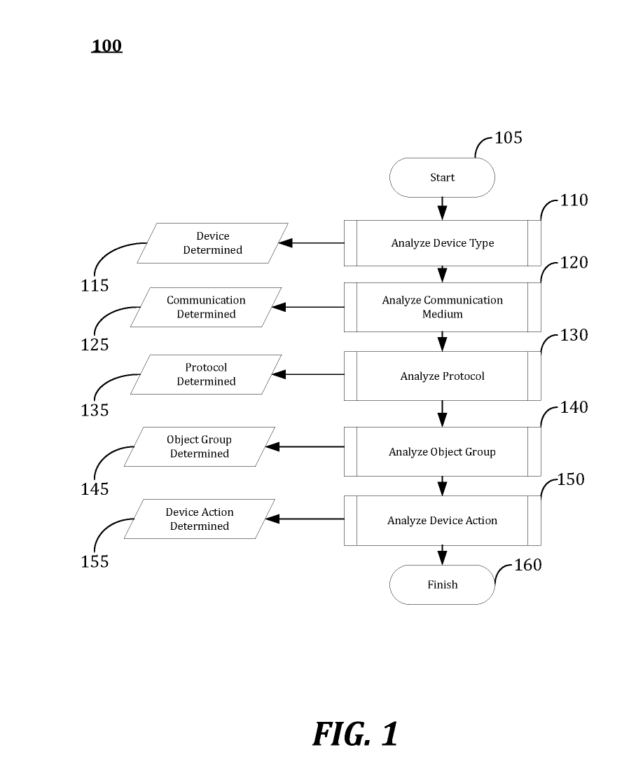

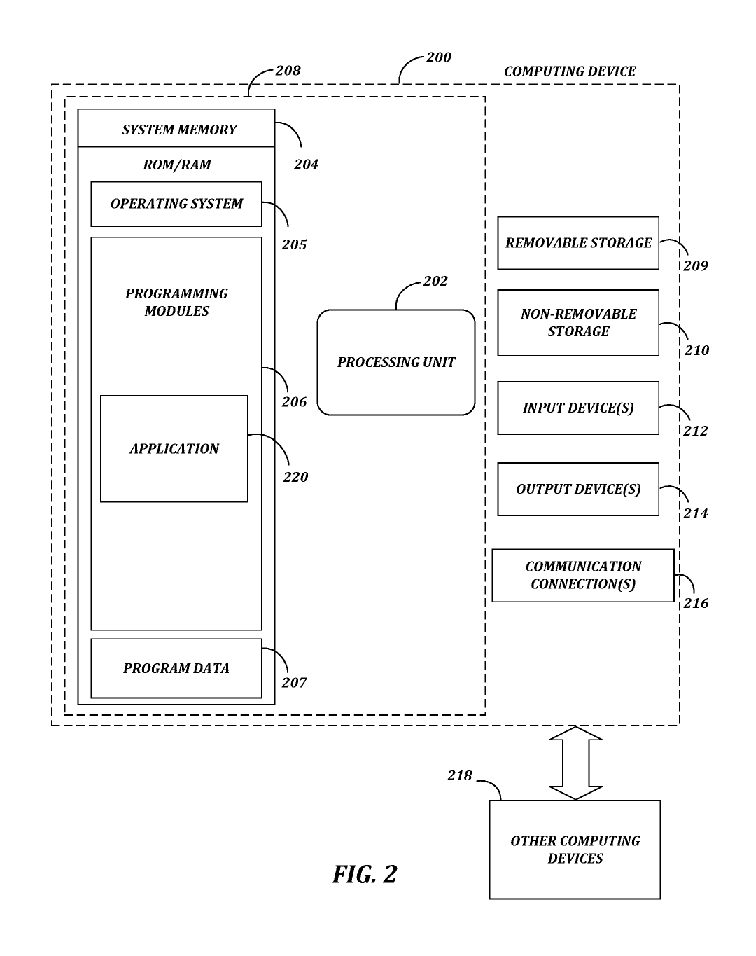

FIG. 1 is a flow chart setting forth the general stages involved in a method 100 consistent with an embodiment of the invention for providing the ICS Emulation Platform for Malware Analysis. Method 100 may be implemented using a computing device 200 having the ICS Emulator module installed thereon. Computing device and the module are described in more detail below with respect to FIG. 2. Ways to implement the stages of method 100 will be described in greater detail below.

Although method 100 has been described to be performed by computing device 200, it should be understood that, in some embodiments, different operations may be performed by different networked elements in operative communication with computing device 200. For example, computing device 200 may be employed in the performance of some or all of the stages in method 100.

Method 100 may begin at starting block 105 where computing device 200 monitors malware. For example, the malware may be detected and communicated to the emulator. The detection may be automated by a malware detection tool. In some embodiments, the malware may be inputted manually to the emulator for analysis. In other embodiments, the malware may be automatically communicated to the emulator by, for example, the malware detection tool. Method 100 may then proceed to stage 110 where computing device 200 may analyze and determine a type of device with which the malware is attempting to communicate. For example, a determination may be made that the malware is attempting to communicate with an ICS device of, by way of non-limiting example, one of the following types: an RTU, PLC, HMI, IED or any other ICS device. The determined device may be stored in block 115.

From stage 110, where computing device 200 has determined the device type, method 100 may advance to stage 120 where computing device 100 may analyze and determine a communication medium through which the malware is attempting to communicate with the ICS device. For example, the malware may be communicating with the ICS device through communication medium that may comprise, but not be limited to, for example, a serial, Ethernet or Fiber transmission line. The communication medium may be stored in block 125.

Once computing device 200 determines the communication medium in stage 120, method 100 may continue to stage 130 where computing device 200 may determine a communication protocol used by the malware to communicate with the ICS device. For example, the malware may be configured to communicate in at least one of the following protocols: TCP, UDP, ICCP (IEC 60870-6), IEC 60870-5, IEC 61850, MODBUS, DNP3 or OLE/OPC. The communication protocol may be stored in block 135.

In various embodiments, in order for computing device 200 to monitor the malware over a particular protocol, authentication may be required. In these embodiments, computing device 200 and the corresponding ICS Emulator module may be configured with a password for authentication. The password may be, for example, provided by a user (e.g., an operator) of computing device 200 or pre-configured into the software.

After computing device 200 determines the communication protocol in stage 130, method 100 may proceed to stage 140 where computing device 200 may analyze and determine data types by object groups being communicated by the malware to the ICS device. The determined group object may be stored in block 145. The malware communication may comprise, for example, but not be limited to:
Binary Inputs;
Binary Outputs;
Analog Inputs;
Analog Outputs;
Digital Inputs;
Digital Outputs;
Counters; and
File Transfer Objects.
   After computing device 200 has determined the object group in stage 140, method 100 may proceed to stage 150 where computing device 200 may analyze and determine an action that the malware is requesting the ICS device to perform. The determined device action may be stored in block 255. By way of non-limiting example, the malware may attempt to cause the ICS device to perform at least one of the following actions:
Acknowledge Exception Code Delay;
Broadcast Request from an Authorized Client;
Broadcast Request from an Unauthorized Client;
Clear Counters and Diagnostic Registers;
Cold Restart from Authorized Client;
Cold Restart from Unauthorized Client;
Disable Unsolicited Responses;
Failed Checksum Error;
Force Listen Only Mode;
Function Code Scan;
Illegal Packet Size, Possible DOS Attack;
Incorrect Packet Length, Possible DOS Attack;
Non-DNP3 Communication on a DNP3 Port;
Non-Modbus Communication on TCP Port 502;
Points List Scan;
Read Device Identification;
Report Slave ID;
Restart Communications Option;
Slave Device Busy Exception Code Delay;
Stop Application;
Time Change Attempt;
Unauthorized Miscellaneous Request to a PLC;
Unauthorized Read Request to a PLC;
Unauthorized Write Request to a PLC; and
Unsolicited Response Storm.

Once computing device 200 analyzes and determines an action that the malware is requesting the ICS device to perform in stage 150, method 100 may then end at stage 160.

### IV. PLATFORM ARCHITECTURE

FIG. 2 is a block diagram of a system including computing device 200. Consistent with an embodiment of the invention, method 100 may be implemented in a computing device, such as computing device 200 of FIG. 2. Any suitable combination of hardware, software, or firmware may be used to implement the memory storage and processing unit. For example, the memory storage and processing unit may be implemented with computing device 200 or any of other computing devices 218, in combination with computing device 200. The aforementioned system, device, and processors are examples and other systems, devices, and processors may comprise the aforementioned memory storage and processing unit, consistent with embodiments of the invention. Furthermore, computing device 200 may comprise an operating environment for system 100 as described above. System 100 may operate in other environments and is not limited to computing device 200.

With reference to FIG. 2, a system consistent with an embodiment of the invention may include a computing device, such as computing device 200. In a basic configuration, computing device 200 may include at least one processing unit 202 and a system memory 204. Depending on the configuration and type of computing device, system memory 204 may comprise, but is not limited to, volatile (e.g. random access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include an ICS Emulator Module. Furthermore, embodiments of the invention may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and nonvolatile, removable and non-removable media implemented in any method or technology for storage of information, such as computer readable instructions, data structures, program modules, or other data. System memory 204, removable storage 209, and non-removable storage 210 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g. ICS Emulator 220) may perform processes including, for example, one or more method 100's stages as described above. The aforementioned process is an example, and processing unit 202 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

I claim the following:

1. A method comprising:
detecting malware or a malware attack capable of controlling an Industrial Control System (ICS) device;
emulating at least one Industrial Control System (ICS) device;
simulating the malware attack; and
performing a behavior analysis.

2. The method of claim 1, wherein emulating the at least one ICS device comprises emulating at least one of the following:
a Supervisory Control and Data Acquisition (SCADA) system,
a Distributed Control System (DCS),
a Programmable Logic Controller (PLC),
a Human Management Interface (HMI),
a Remote terminal unit (RTU), and
an Intelligent Electronic Device (IED).

3. The method of claim 1, wherein performing the behavior analysis comprises comparing effects of the simulated malware attack on the emulated at least one ICS device with effects of the simulated malware attack on an actual ICS device.

4. The method of claim 1, further comprising:
detecting a communication medium through which the malware is attempting to communicate with the ICS device;
detecting a communication protocol through which the malware is attempting to communicate with the ICS device;
determining at least one data type being communicated by the malware to the ICS device; and
determining an at least one action that the malware is requesting the ICS to perform.

5. The method of claim 4, wherein detecting the communication protocol comprises detecting at least one of the following:
TCP,
UDP,
ICCP,
IEC 60870-6,
IEC 60870-5,
IEC 61850,
MODBUS, and
DNP3.

6. The method of claim 4, further comprising authenticating communication over a specific protocol, wherein authenticating comprises authenticating at least one of the following:
an operator, and
a preconfigured password.

7. The method of claim 4, wherein determining the at least one data type comprises determining at least one of the following:
a binary input,
a binary output,
an analog input,
an analog output,
a digital input,
a digital output,
a counter, and
a file transfer object.

8. The method of claim 4, wherein detecting at least one action that the malware is requesting the ICS to perform comprises detecting a request for the ICS to perform at least one of the following:
Acknowledging Exception Code Delay,
Broadcasting Request from an Authorized Client,
Broadcasting Request from an Unauthorized Client,
Clearing Counters and Diagnostic Registers,
Cold Restarting from Authorized Client,
Cold Restarting from Unauthorized Client,
Disabling Unsolicited Responses,
Failing Checksum Error,
Forcing Listen Only Mode,
Function Code Scanning,
Force Illegal Packet Sizing,
Force Incorrect Packet Length,
Non-DNP3 Communicating on a DNP3 Port,
Non-Modbus Communicating on TCP Port 502,
Points List Scanning,
Reading Device Identification,
Reporting a Slave ID,
Restarting Communications Option,
Sending Slave Device Busy Exception Code Delay,
Stopping Application,
Attempting Time Change,
Unauthorized Miscellaneous Requesting to a PLC,
Unauthorized Read Requesting to a PLC,
Unauthorized Write Requesting to a PLC, and
Unsolicited Response Storming.

9. The method of claim 4, wherein detecting the communication medium comprises detecting at least one of the following:
a serial line,
an Ethernet line, and
a Fiber transmission line.

10. A computer readable medium comprising a set of instructions which when executed perform a method comprising:
detecting malware or a malware attack capable of controlling an Industrial Control System (ICS) device;
detecting a communication medium through which the malware is attempting to communicate with an Industrial Control System (ICS) device;
detecting a communication protocol through which the malware is attempting to communicate with the ICS device;
determining at least one data type being communicated by the malware to the ICS device; and
determining an at least one action that the malware is requesting the ICS to perform.

11. The computer-readable medium of claim 10, wherein detecting the communication protocol comprises detecting at least one of the following:
TCP,
UDP,
ICCP,
IEC 60870-6,
IEC 60870-5,
IEC 61850,
MODBUS, and
DNP3.

12. The computer-readable medium of claim 10, further comprising authenticating communication over a specific protocol, wherein authenticating comprises authenticating at least one of the following:
an operator, and
a preconfigured password.

13. The computer-readable medium of claim 10, wherein determining the at least one data type comprises determining at least one of the following:
a binary input,
a binary output,
an analog input,
an analog output,
a digital input,
a digital output,
a counter, and
a file transfer object.

14. The computer-readable medium of claim 10, wherein detecting at least one action that the malware is requesting the ICS to perform comprises detecting a request for the ICS to perform at least one of the following:
Acknowledging Exception Code Delay,
Broadcasting Request from an Authorized Client,
Broadcasting Request from an Unauthorized Client,
Clearing Counters and Diagnostic Registers,
Cold Restarting from Authorized Client,
Cold Restarting from Unauthorized Client,
Disabling Unsolicited Responses,
Failing Checksum Error,
Forcing Listen Only Mode,
Function Code Scanning,
Forcing Illegal Packet Sizing,
Forcing Incorrect Packet Length,
Non-DNP3 Communicating on a DNP3 Port,
Non-Modbus Communicating on TCP Port 502,
Points List Scanning,
Reading Device Identification,
Reporting a Slave ID,
Restarting Communications Option,
Sending Slave Device Busy Exception Code Delay,
Stopping Application,
Attempting Time Change,
Unauthorized Miscellaneous Requesting to a PLC,
Unauthorized Read Requesting to a PLC,
Unauthorized Write Requesting to a PLC, and
Unsolicited Response Storming.

15. The computer-readable medium of claim 10, wherein detecting the communication medium comprises detecting at least one of the following:
a serial line,
an Ethernet line, and
a Fiber transmission line.

16. A system comprising:
a memory storage;
a processing unit coupled to the memory storage, wherein the processing unit is operative to:
emulate at least one Industrial Control System (ICS) device,
simulate malware or a malware attack capable of controlling an Industrial Control System (ICS) device,
perform a behavior analysis,
detect the malware attack,
detect a communication medium through which the malware is attempting to communicate with the ICS device,
detect a communication protocol through which the malware is attempting to communicate with the ICS device,
determine at least one data type being communicated by the malware to the ICS device; and
determine an at least one action that the malware is requesting the ICS to perform.

17. The system of claim 16, wherein the at least one ICS device comprises at least one of the following:
a Supervisory Control and Data Acquisition (SCADA),
a Distributed Control System (DCS),
a Programmable Logic Controller (PCL),
a Human Management Interface (HMI),
a Remote terminal unit (RTU), and
an Intelligent Electronic Device (IED).

18. The system of claim 16, wherein the processing unit being operative to perform the behavior analysis comprises the processing unit being operative to compare effects of the simulated malware attack on the emulated at least one ICS device with effects of the simulated malware attack on an actual ICS device.

19. The system of claim 16, wherein the processing unit is further operative to authenticate communication over a specific protocol from at least one of the following:
an operator, and
a preconfigured password.

20. The system of claim 16, wherein the communication medium comprises at least one of the following:
a serial line,
an Ethernet line, and
a Fiber transmission line.
